(19) United States
(12) Patent Application Publication
(10) Pub. No.: US 2026/0336000 A1
(43) Pub. Date: Oct. 29, 2026

(54) APPARATUS FOR PERFORMING SUPERFINISHING OPERATION ON THREADS OF A BALL SCREW

(71) Applicant: GRIND MASTER MACHINES PRIVATE LIMITED, Aurangabad- Maharashtra (IN)

(72) Inventors: Milind Dinkar KELKAR, Aurangabad- Maharashtra (IN); Venkatesh Prakashrao KULKARNI, Aurangabad- Maharashtra (IN)

(21) Appl. No.: 19/117,695

(22) PCT Filed: Jul. 22, 2024
(86) PCT No.: PCT/IB2024/057112

§ 371 Date: Apr. 2, 2025

(30) Foreign Application Priority Data
Jul. 21, 2023 (IN) 202323049392

(51) Int. Cl. B23G 9/00; B24B 21/00; B24B 21/02

(52) U.S. Cl. CPC B23G 9/004; B24B 21/004; B24B 21/02

(57) ABSTRACT

An apparatus for performing super finishing operation on threads of a ball screw includes at least one holder, a first replaceable finishing tool having a threaded section on an operative inner concave section, and a second replaceable finishing tool having a threaded section on an operative inner concave section. The apparatus further includes a slit film-backed abrasive belt, configured to be continuously fed within the inner concave sections to form an interface between the finishing tools and the threads of the ball screw, and at least one driving means, configured to angularly displace the holder to facilitate linear displacement of the finishing tools relative to the ball screw. The apparatus supports the self-weight of the ball screw while machining and thus avoids bulging of the ball screw.

### FIELD

The present disclosure relates to the field of superfinishing technology. Particularly to a field of superfinishing operation on the threads of a ball screw.

### DEFINITION

As used in the present disclosure, the following terms are generally intended to have the meaning as set forth below, except where the context indicates otherwise.

BALL SCREW: The term ‘BALL SCREW’ as used in the context of this disclosure refers to, but is not limited to, ball screw is a mechanical linear actuator that converts rotational motion into linear motion with minimal friction. The ball screw is defined by a first end, a second end and a cylindrical body with a longitudinal helical raceway for balls.

SUPERFINISHING: The term ‘SUPERFINISHING’ used in the context of this disclosure refers to, but is not limited to, a machining or a polishing process which improves the surface roughness to a finer level roughness by removing only a skin layer (1-10 microns), which also leads to improve the anti-friction condition, also causes reducing vibrations by some extend.

### BACKGROUND

A ball screw is a mechanical linear actuator that converts rotational motion into linear motion with minimal friction. Conventionally, a ball screw includes a threaded shaft which provides a helical raceway for balls and functions as a precision screw. Ball screws are generally used in steering systems for automobiles and for motion transmission in machine tools.

During manufacturing, it is required that ball screws undergo a superfinishing operations after heat treatment. Conventional methods of performing finishing operations on ball screws include manual/semi-automatic processes, which are unreliable due to human intervention. For example, polishing the ball screw manually using various abrasives, precision machining, grinding methods, and the like. However, using these conventional finishing methods, the ball screw is susceptible to deformation or bending caused by its own self weight and the forces generated during the machining process. As a result, the threads of the ball screw end up with an uneven surface finish, impeding its optimal performance. Further, to support the self-weight of the ball screw, conventional superfinishing methods require a separate attachment, which hinders the machining process.

Accordingly, there exists a need to provide an apparatus for performing super finishing operations on threads of ball screws which overcomes the abovementioned drawbacks.

### OBJECTS

Some of the objects of the present disclosure, which at least one embodiment herein satisfies, are as follows:

An object of the present disclosure is to provide an apparatus for performing super finishing operation on threads of a ball screw.

Another object of the present disclosure is to provide an apparatus which supports the self-weight of the ball screw while superfinishing or machining.

Still another object of the present disclosure is to provide an apparatus which performs the finishing operation of the threads while supporting the ball screw.

Yet another object of the present disclosure is to provide an apparatus which is simple and economical.

Still another object of the present disclosure is to provide an apparatus which reduces the machine lead time.

Other objects and advantages of the present disclosure will be more apparent from the following description, which is not intended to limit the scope of the present disclosure.

### SUMMARY

The present disclosure envisages an apparatus for performing a superfinishing operation on threads of a ball screw. The ball screw is defined by a first end and a second end and a cylindrical body provided with a longitudinal helical raceway for balls. The apparatus comprises at least one holder to removably hold the ball screw; a first replaceable finishing tool provided with a first inner concave section defining a threaded section complementary to the threads of the ball screw; and a second replaceable finishing tool provided with a second inner concave section defining a threaded section complementary to the threads of the ball screw. The first and the second inner concave sections are configured to operatively abut to form a hollow cylindrical cavity and further configured to clamp an operative cylindrical section of the ball screw within the cavity. A slit film-backed abrasive belt is configured to be received on an operative section of the first replaceable finishing tool and the second finishing tool and continuously fed within circumferential surface of the cavity to form an interface between the finishing tools and the operative cylindrical body section containing threads of the ball screw; and at least one driving means is configured to angularly displace the holder to facilitate the angular displacement of the ball screw mounted thereon relative to the threaded section of the inner concave sections. The ball screw is held at or near the center of the holder to facilitate rotational motion. The first replaceable finishing tool, the second replaceable finishing tool, the abrasive belt and the arms are mounted on a slidable carriage (54, 56) (longitudinal slide) which traverses along the length of the treaded portion of the ball screw by virtue of complementary threads present on the first replaceable finishing tool and the second replaceable finishing tool and the threads present on the ball screw. to facilitate the superfinishing operation on the threads of the ball screw via the first finishing tool, the second finishing tool and the abrasive belt.

In an embodiment, the first replaceable finishing tool and the second replaceable finishing tool are defined by “C” shaped bodies.

In an embodiment, the apparatus includes a pair of arms. Each arm is configured to mount the first replaceable finishing tool and the second replaceable finishing tool, respectively. The arms are configured to be pivotally mounted on the apparatus to support the self-weight of the ball screw in an operative configuration of the apparatus.

In an embodiment, the pivot axis of the arms and the centroidal axis of the ball screw are parallel in an operative configuration of the apparatus. In an embodiment, the pivot axis of the arms and the centroidal axis of the ball screw are coplanar in an operative configuration of the apparatus. In an embodiment, the centroidal axis (C) is perpendicular to an axis (M) passing perpendicular from the pivot axis (P).

In an embodiment, the finishing tool is configured to slide back and forth to move the ball screw through the cavity longitudinally for performing the finishing operation on the ball screw in an operative configuration of the apparatus.

In an embodiment, the slit film-backed abrasive is a non-woven abrasive tape. The thickness of the slit film backed abrasive tape is in range from 0.2 mm to 1.0 mm.

In an embodiment, the driving means is configured to facilitate the alternate clockwise and counterclockwise angular displacement of the ball screw within the concave sections, to provide the first finishing tool and the second finishing tool a traversing reciprocal motion in forward and reverse strokes to perform the superfinishing operation on the threads of the ball screw.

In an embodiment, the slit film backed abrasive tape is provided with a pitch, which is equal to the pitch defined on the threaded section of the inner concave sections of the finishing tool and pitch defined on the thread of the ball screw.

In an embodiment, the apparatus includes a gear-driven indexing mechanism. The indexing mechanism is configured to control the movement of the slit film-backed abrasive tape between the inner concave sections of the finishing tools and the operative section of the ball screw.

### BRIEF DESCRIPTION OF THE ACCOMPANYING DRAWING

An apparatus for performing super finishing operation on the threads of a ball screw, of the present disclosure, will now be described with the help of the accompanying drawing, in which:

FIG. 1A illustrates a schematic view of a conventional apparatus for performing finishing operation on a ball screw;

FIG. 2 illustrates isometric view of a finishing tool with the ball screw of the conventional apparatus for performing a finishing operation on a ball screw;

FIG. 3 illustrates an isometric view of a finishing tool used in the conventional apparatus of FIG. 1 and FIG. 2;

FIG. 4 illustrates a schematic view of the present replaceable finishing tool of the present apparatus with the ball screw for performing superfinishing operation on threads of a ball screw, in accordance with an embodiment of the present disclosure;

FIG. 5 illustrates a schematic view of the present replaceable finishing tool of the present apparatus mounted on a gripping means, in accordance with an embodiment of the present disclosure;

FIG. 6 illustrates a schematic view of the slit film backed abrasive in respective concave section of the replaceable finishing tool of the present apparatus, in accordance with an embodiment of the present disclosure;

FIG. 7 illustrates a schematic arrangement of the slit film-- backed abrasive in respective concave section of the replaceable finishing tool and the ball screw of the present apparatus, in accordance with an embodiment of the present disclosure;

FIG. 8 illustrate a schematic view of arms with the gripping means and an actuator, in accordance with an embodiment of the present disclosure;

FIG. 9 illustrates an isometric view of at least one holder with the ball screw mounted therein, and the arms with the replaceable finishing tool, in accordance with an embodiment of the present disclosure;

FIG. 10 illustrates an isometric view of the superfinishing apparatus with the ball screw mounted between the centers of the headstock and the tailstock, along with the respective directions of movement for both the ball screw and the finishing tool in accordance with the present disclosure; and

FIG. 11 illustrates the top view of the superfinishing apparatus with the ball screw mounted between the centers of the headstock and the tailstock, along with pair of driving means in accordance with the present disclosure.

### LIST OF REFERENCE NUMERALS

100′ Conventional Apparatus for performing super finishing operation
100 Apparatus of present disclosure for performing super finishing operation on threads of a ball screw
10 First replaceable Finishing tool
10A first concave section of First replaceable Finishing tool
15 Second replaceable finishing tool
15A second concave section of Second replaceable finishing tool
20 Slit film backed abrasive belt
30 Gripping means
40 Ball screw
40A Threads of the ball screw
42 Headstock
44a, 44b Driving means
46 Arm
48 cylindrical cavity
50 Actuator
52 Tailstock
54 long slide
56 cross slide
P Pivot axis of arms
C Centroidal axis of ball screw

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including” and “having” are open-ended transitional phrases and therefore specify the presence of stated features, elements, modules, units and/or components, but do not forbid the presence or addition of one or more other features, elements, components, and/or groups thereof.

When an element is referred to as being “mounted on”, “engaged to”, “connected to” or “coupled to” another element, it may be directly on, engaged, connected or coupled to the other element. As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Terms such as “bottom”, “inner”, “outer”, “beneath”, “below”, “lower”, “above”, “upper” and the like, may be used in the present disclosure to describe relationships between different elements as depicted from the figures.

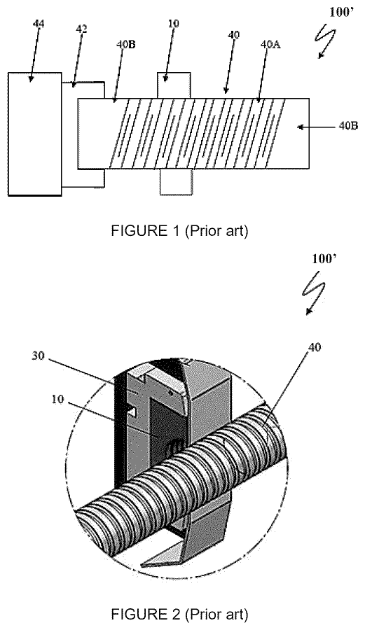

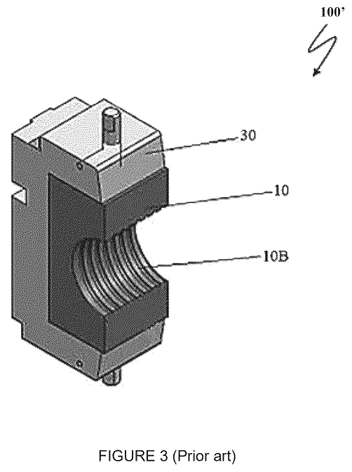

During manufacturing, ball screws require super finishing operations after heat treatment. Conventional apparatuses (100′) and methods for performing finishing operations on ball screws (40) typically involve manual or semi-automatic processes, which are unreliable due to human intervention. An example includes conventionally polishing the ball screw manually using various abrasives, precision machining, grinding methods, and the like. FIG. 1A illustrates a schematic view of a conventional apparatus for performing a finishing operation on a ball screw; FIG. 2 illustrates isometric view of a finishing tool with the ball screw using the conventional apparatus for performing finishing operation on a ball screw; and FIG. 3 illustrates an isometric view of a finishing tool used in the conventional apparatus of FIG. 1 and FIG. 2.

However, using these conventional methods, the ball screw is susceptible to deformation or bending caused by its own self weight and the forces generated during the machining process. As a result, the threads of the ball screw end up with an uneven surface finish, impeding optimal performance. Further, to support the self-weight of the ball screw during the superfinishing process, conventional methods require a separate attachment, which hinders the machining process.

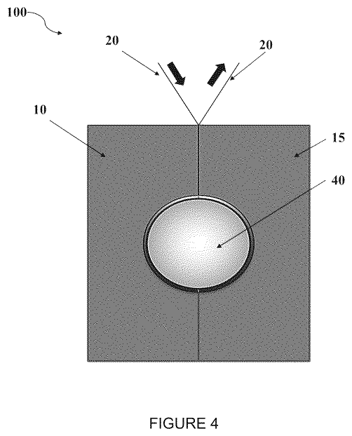

In order to address the aforementioned problems, the present disclosure envisages an apparatus (100) for performing superfinishing operations on the threads of a ball screw. The apparatus (100) is meticulously crafted to enhance the surface quality and precision of the ball screw threads, which are critical for the efficient functioning of mechanical systems where ball screws are employed. The present disclosure is explained with reference to the FIG. 4 to FIG. 9. The ball screw (40) is defined by a first end and a second end and a cylindrical body with a longitudinal helical raceway thereon for balls.

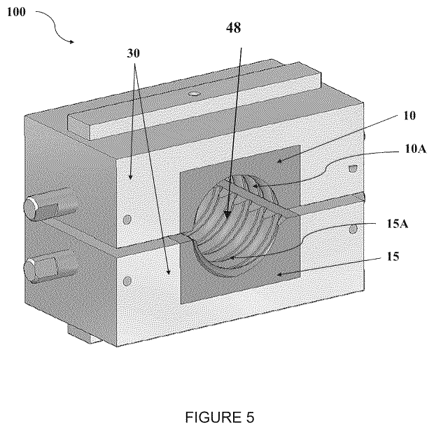

The apparatus (100) comprises at least one holder (42, 52), a first replaceable finishing tool (10), a second replaceable finishing tool (15), a slit film-backed abrasive tape belt (20) and at least one driving means (44a, 44b). FIG. 4 illustrate a schematic view of the present replaceable finishing tool of the present apparatus for the ball screw for performing a super finishing operation on threads of the ball screw, FIG. 5 illustrate a schematic view of the present replaceable finishing tool of the present apparatus mounted on a gripping means.

The holder (42, 52) is configured to removably hold the extreme ends. i.e. the first end and the second end of the ball screw (40). In an embodiment, the first end is mounted on headstock and the second end is mounted on the tailstock (52) of the apparatus. Therefore, the ball screw (40) is held between the center of the holder (42, 52) to facilitate rotational motion. The first replaceable finishing tool (10), the second replaceable finishing tool (15), the abrasive belt (20) and the arms are mounted on a slidable carriage which includes long slide (54) and the cross slide (56) which traverse along the length of the threaded portion of the ball screw (40) by virtue of the complementary threads present on the first replaceable finishing tool (10) and the second replaceable finishing tool (15) and the threads present on the ball screw (40). The complementary threads of the ball screw (40) and the finishing tool (10, 15) enable the movement of the finishing tools (10, 15) from one end to another end of the ball screw (40) parallel to the sliding bed. The movement of the finishing tools (10, 15) over the bed enable the superfinishing operation of the threads (40A) of the ball screw (40) to a desired length in an operative configuration of the apparatus (100).

In an embodiment, the ball screw (40) is held between the centers, one end with the headstock (42), and the other end clamped by a pneumatic tailstock (52).

Further, the apparatus (100) is provided with splitable arms. These arms are configured to split and separate as two independent arms (46) to hold and support the operative cylindrical section of the ball screw (40) while in operation. Each arm (46) is actuated by means of an actuator (50) and is configured to attach at least one gripping means (30). These arms (46) are pivotally mounted on the apparatus (100), with the pivot axis (P) parallel or coplanar with the centroidal axis (C) of the ball screw (40). This configuration supports the self-weight of the ball screw (40) and allows precise control during the superfinishing operation.

In an embodiment, each arm (46) splits in an operative vertical direction to optimize the space requirements and utilize the vertical space of the apparatus (100).

In an embodiment, the gripping means (30) is either slidably mounted or fastened to the operative extreme end of each of the arms (46).

In an embodiment, the arms (46) are configured to be pivotally mounted (P) on the apparatus (100) to thereby support the self-weight of the ball screw (40) in an operative configuration of the apparatus (100).

The gripping means (30) is defined with a cut-out to receive the finishing tools therein. The finishing tools are divided into the first replaceable finishing tool (10) and the second replaceable finishing tool (15), each defined by a “C” shaped body structure with a first concave section (10A) and a second concave section (15A). The first operative concave section (10A) and the second operative concave section (15A) of each of the replaceable finishing tools (10, 15) are configured with a threaded section.

In an embodiment, the threaded sections provided on the concave sections (10A, 15A) of the first and second replaceable finishing tools (10, 15) are complementary to the threads (40A) of the ball screw (40). The first and the second inner concave sections (10A, 15A) operatively abut to form a hollow cylindrical cavity (48), which clamps an operative cylindrical section of the ball screw (40) within the cavity (48).

In an embodiment, the first and the second inner concave sections (10A, 15A) of the first replaceable finishing tool (10) and the second replaceable finishing tool (15) are configured to partially cover the operative cylindrical section of the ball screw (40) in an operative configuration of the apparatus (100).

During machining, the first replaceable finishing tool (10) and the second replaceable finishing tool (15) partially cover the operative cylindrical section of the ball screw (40) and supports the ball screw (40). Advantageously, it avoids the possibility of bulging of the ball screw (40) due to its self-weight or due to the force generation while machining or superfinishing.

In an embodiment, the centroidal axis (C) is perpendicular to an axis (M) passing perpendicular from the pivot axis (P).

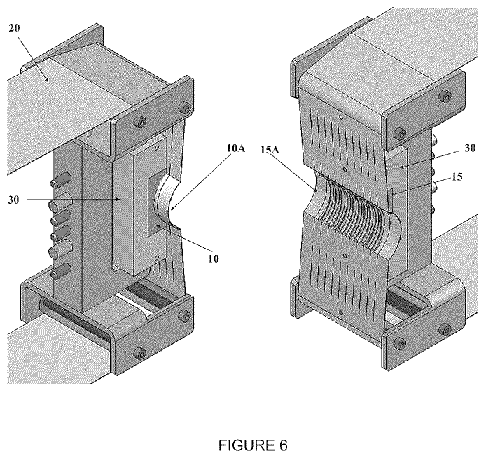

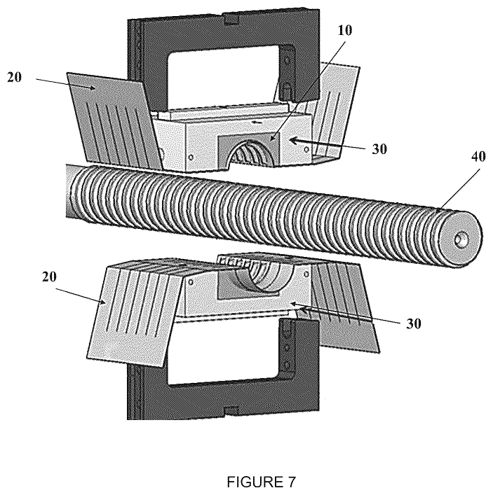

The apparatus is configured with the slit film-backed abrasive belt (20). The abrasive belt (20) is received on an operative section of the first replaceable finishing tool (10) and the second finishing tool (15) and is configured to be continuously fed within a circumferential surface of the first and the second inner concave sections (10A, 15A) of the first finishing tool (10) and the second finishing tool (15). The slit film, thus forms an interface between the threaded sections of the concave sections (10A, 15A) of the replaceable finishing tools (10, 15) and the threads (40A) of the ball screw (40) during machining or superfinishing. The slit film is provided with a uniform pitch along the width of slit film. The pitch defined on the slit film backed abrasive belt (20) is equal to pitch defined on the threaded section of the inner concave sections (10A, 15A) of the finishing tools and pitch defined on the thread (40A) of the ball screw (40). FIG. 6 illustrates a schematic view of the slit film backed abrasive belt in respective concave section of the replaceable finishing tool of the present apparatus; and FIG. 7 illustrates a schematic arrangement of the slit film backed abrasive belt in respective concave section of the replaceable finishing tool and the ball screw of the present apparatus, in accordance with an embodiment of the present disclosure.

In an embodiment, the slit film-backed abrasive belt (20) is configured to be driven at the interface formed between the threaded section of the replaceable finishing tools (10, 15) and the threads (40A) of the ball screw (40) by means of a gear-driven indexing mechanism. The indexing mechanism controls the movement of the slit film-backed abrasive belt (20) between the first and the second inner concave sections (10A, 15A) of the finishing tools (10, 15) and the operative cylindrical section containing threads (40A) of the ball screw (40).

In an embodiment, the slit film-backed abrasive belt (20) is a non-woven abrasive belt.

In an embodiment, the depth of the individual slit of the continuous slit film-backed abrasive belt (20) is equal to difference between the major diameter and the minor diameter of the thread (40A) of the ball screw (40) in an operative configuration of the apparatus (100).

In an embodiment, the thickness of the slit film-backed abrasive belt (20) ranges from 0.2 mm to 1.0 mm.

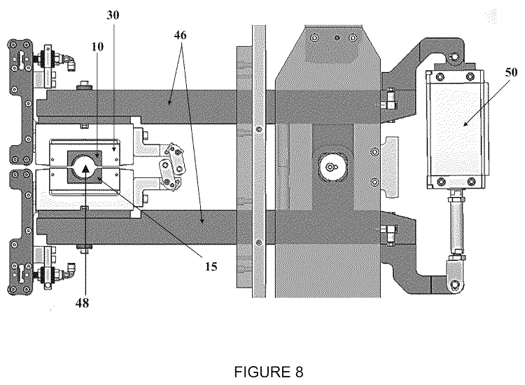

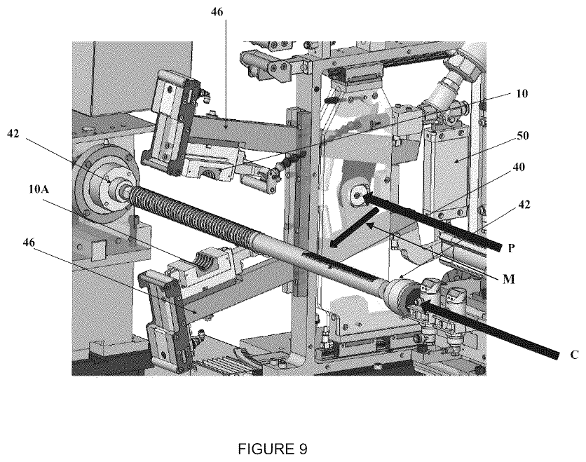

Further, the apparatus (100) includes at least one driving means (44a, 44b). The driving means (44a, 44b) is configured to be operatively coupled with the holder (42) and is further configured to angularly displace the holder (42) to facilitate the angular displacement of the ball screw (40) mounted thereon relative to the threaded section provided on the first and the second concave sections (10A, 15A) of the first and second replaceable finishing tools (10, 15) during machining. The first replaceable finishing tool (10), the second replaceable finishing tool (15), with the abrasive belt (20) traverse along the length of the threaded portion of the ball screw (40) by virtue of the complementary threads present on the first replaceable finishing tool (10) and the second replaceable finishing tool (15) and the threads present on the ball screw (40) to facilitate the superfinishing operation on the threads (40A) of the ball screw (40) via the first finishing tool (10), the second finishing tool (15) and the abrasive belt (20), thus the desired length of the ball screw gets superfinished. FIG. 9 illustrates an isometric view of at least one holder with the ball screw mounted therein, and the arms with the replaceable finishing tool, in accordance with an embodiment of the present disclosure. FIG. 8 illustrate a schematic view of arms with the gripping means and an actuator.

In an embodiment, the apparatus (100) may have only one driving means (44a, 44b), which is configured to angularly displace the ball screw (40) as well as to move the slit film-backed abrasive belt (20) in an operative configuration of the apparatus (100).

In another embodiment, the apparatus (100) may have two separate driving means (44a, 44b), one is coupled with the cross slide (56) and the other is coupled with the long slide (54). The two-driving means (44a, 44b) are configured to rotate at two different speed ratios.

In another embodiment, the driving means (44a, 44b) is configured to facilitate the alternate clockwise and counterclockwise angular displacement of the ball screw (40) within the concave sections (10A, 15A), to provide the first finishing tool (10) and the second finishing tool (15) a traversing reciprocal motion in forward and reverse strokes to perform the superfinishing operation on the threads (40A) of the ball screw (40). FIG. 9 illustrates an isometric view of at least one holder (42) with the ball screw mounted therein, and the arms with the replaceable finishing tools (10, 15).

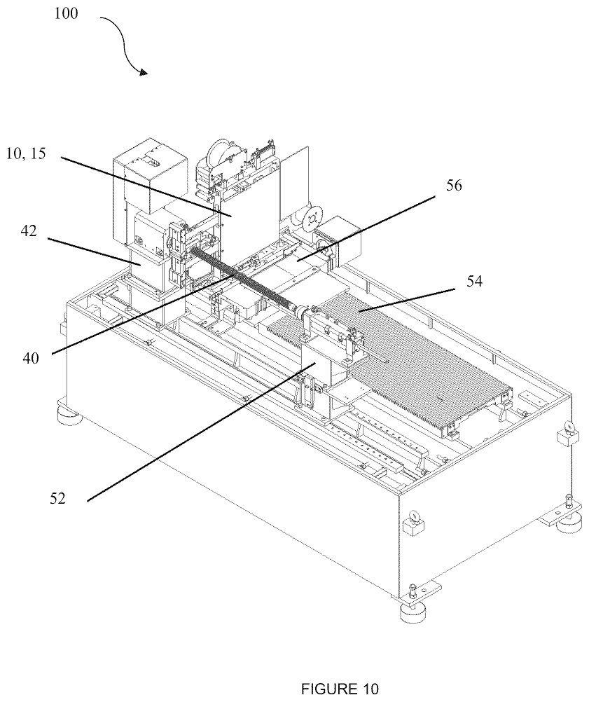

FIG. 10 illustrates the superfinishing apparatus, featuring the ball screw (40) positioned between the centres of the holder. i.e. headstock (42) and the tailstock (52). The figure also indicates the directional movement of the ball screw (40), whether in clockwise or anti-clockwise angular displacement, and the traversal direction of the finishing tools (10, 15) along the threaded portion (40A) of the ball screw (40). This configuration ensures precise control over the finishing process, thereby enhancing the surface quality of the ball screw (40). The alignment and movement dynamics are configured to optimize the superfinishing operation of the ball screw (40).

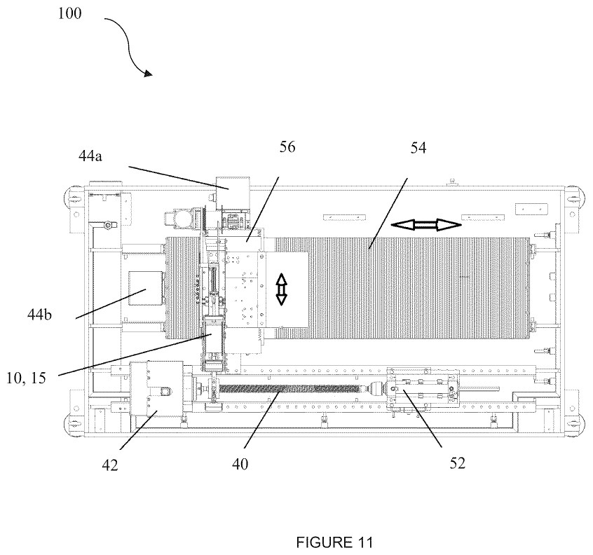

FIG. 11 illustrates a top view of the superfinishing apparatus, showing the ball screw mounted between the centres of the headstock and tailstock, along with a pair of driving means, as disclosed herein. The pair of driving means includes the first driving means which is associated with the long slide (54) and the second driving means associated with the cross slide (56) of the apparatus (100).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements and Economic Significance

The present disclosure described herein above has several technical advantages including, but not limited to, the realization of the apparatus for performing super finishing operation on threads of a ball screw, that:
supports the self-weight of the ball screw while machining and thus avoid the bending of the ball screw during superfinishing operation;
performs the finishing operation of the threads while supporting the ball screw;
is simple and economical; and
reduces the machine lead time.

The embodiments herein and the various features and advantageous details thereof are explained with reference to the non-limiting embodiments in the following description. Descriptions of well-known components and processing techniques are omitted so as to not unnecessarily obscure the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. An apparatus (100) for performing a superfinishing operation on threads of a ball screw, the ball screw (40) defined by a first end and a second end and a cylindrical body having a longitudinal helical raceway for balls, said apparatus (100) comprising:
at least one holder (42) to removably hold the ball screw (40);
a first replaceable finishing tool (10) having a first inner concave section (10A) defining a threaded section complementary to the threads (40A) of the ball screw (40);
a second replaceable finishing tool (15) having a second inner concave section (15A) defining a threaded section complementary to the threads (40A) of the ball screw (40), said first inner concave section (10A) and said second inner concave section (15A) configured to operatively abut to form a hollow cylindrical cavity (48) and further configured to clamp an operative cylindrical section of the ball screw (40) within said cavity (48);
a slit film-backed abrasive (20) belt configured to be received on an operative section of said first replaceable finishing tool (10) and said second finishing tool (15), said slit film-backed abrasive (20) belt configured to be continuously fed within circumferential surface of said cavity (48) to form an interface between the threaded section of said concave sections (10, 15) and the operative cylindrical section containing threads (40A) of the ball screw (40); and
at least one driving means (44a, 44b) configured to be in communication with said holder (42), said driving means (44a, 44b) configured to angularly displace said holder (42) to facilitate the angular displacement of the ball screw (40) relative to the section of threads of said inner concave sections (10A, 15A),
wherein said apparatus is characterized whereby said first replaceable finishing tool, said second replaceable finishing tool, said abrasive belt being mounted on a slidable carriage (54, 56) which traverses along the length of the threaded portion of said ball screw (40) by virtue of the complementary threads present on said first replaceable finishing tool (10) and said second replaceable finishing tool (15) and the threads (40A) present on the ball screw

(40) to facilitate the superfinishing operation on the threads (40A) of said ball screw (40) via said first finishing tool (10), said second finishing tool (15) and said abrasive belt (20).

2. The apparatus (100) as claimed in claim 1, wherein said finishing tools (10, 15) are configured to slide back and forth on the ball screw (40) for performing said superfinishing operation on the threads (40A) of the ball screw (40) in an operative configuration of said apparatus (100).

3. The apparatus (100) as claimed in claim 1, wherein said driving means (44a, 44b) is configured to facilitate the alternate clockwise and counterclockwise angular displacement of the ball screw (40) within said concave sections (10A, 15A), to provide said first finishing tool (10) and said second finishing tool (15) a traversing reciprocal motion in forward and reverse strokes to perform the superfinishing operation on the threads (40A) of the ball screw (40).

4. The apparatus (100) as claimed in claim in 1, wherein said cavity (48) formed by said inner concave sections (10A, 15A) is configured to partially cover said operative cylindrical section of the ball screw (40) in an operative configuration of said apparatus (100).

5. The apparatus (100) as claimed in claim in 1, wherein said first replaceable finishing tool (10) and said second replaceable finishing tool (15) is defined by a “C” shaped body.

6. The apparatus (100) as claimed in claim 5, includes a pair of arms (46), each of said arms (46) is configured to mount said first replaceable finishing tool (10) and said second replaceable finishing tool (15) thereon respectively.

7. The apparatus (100) as claimed in claim 6, said arms (46) are configured to be pivotally mounted on said apparatus (100).

8. The apparatus (100) as claimed in claim 6, wherein pivot axis (P) of said arms and centroidal axis (C) of the ball screw (40) is parallel in an operative configuration of said apparatus (100).

9. The apparatus (100) as claimed in claim 6, wherein the centroidal axis (C) is perpendicular to an axis (M) passing perpendicular from the pivot axis (P).

10. The apparatus (100) as claimed in claim 6, wherein pivot axis (P) of said arms and the centroidal axis (C) of the ball screw (40) is coplanar in an operative configuration of said apparatus (100).

11. The apparatus (100) as claimed in claim in 6, wherein said first replaceable finishing tool (10) and said second replaceable finishing tool (15) are configured to be mounted on said arm (46) by means of a gripping means (30).

12. The apparatus (100) as claimed in claim 1, wherein said slit film backed abrasive belt (20) is a non-woven abrasive.

13. The apparatus (100) as claimed in claim 12, wherein said slit film-backed abrasive belt (20) is provided with a pitch, equal to pitch defined on the threaded section of said inner concave sections (10A, 15A) of said finishing tool and pitch defined on the thread (40A) of the ball screw (40).

14. The apparatus (100) as claimed in claim 1, wherein depth of said individual slit of said continuous slit film backed abrasive belt (20) in said threaded section of said finishing tools (10, 15) is equal to difference between the major diameter and the minor diameter of the thread (40A), and the width and pitch of the ball screw (40) in an operative configuration of said apparatus (100).

15. The apparatus (100) as claimed in claim 1, wherein said apparatus (100) includes a gear driven indexing mechanism which is configured to control the movement of said slit film backed abrasive belt (20) between said inner concave sections (10A, 15A) of said finishing tools (10, 15) and the operative section of the ball screw (40).

16. The apparatus (100) as claimed in claim 1, wherein the thickness of said slit film backed abrasive belt (20) is in range of 0.2 mm to 1.0 mm.
